(19) United States
(12) Patent Application Publication
(10) Pub. No.: US 2020/0303932 A1
(43) Pub. Date: Sep. 24, 2020

(54) QUICK POSITIONING-CHARGING DEVICE

(71) Applicant: CHEN-SOURCE INC., Taoyuan City (TW)

(72) Inventors: Hsing-Chu CHAN, Taoyuan City (TW); Hsin-Hsien TSAI, Taoyuan City (TW)

(21) Appl. No.: 16/356,842

(22) Filed: Mar. 18, 2019

(51) Int. Cl. H02J 7/00

(52) U.S. Cl. CPC H02J 7/0045; H02J 7/0021

(57) ABSTRACT

A quick positioning-charging device including a charging platform including power-terminal connectors which each includes probe terminals, an insulating body, and a female socket electrically connected to the power terminal. Accommodation frames are assembled on the charging platform, and each accommodation frame has an accommodation space for a mobile electronic device to be placed. A male plug of the male plug can be plugged with a charging hole of the mobile electronic device, to form electrical connection. The charging-terminal connector includes contact points for elastically abutting with probe terminals of the power-terminal connector to form electrical connection. The electrical connection structure of the mobile electronic device elastically abutted with the power-terminal connector of the charging platform can prevent the male plug connected to the power supply cable of the conventional charging device from being frequently plugged and pulled with a connector of the mobile electronic device.

### BACKGROUND OF THE INVENTION

### 1. Field of the Invention

The present invention provides a quick positioning-charging device, more particularly to an electrical connection structure in which a mobile electronic device can be elastically abutted with a power-terminal connector of a charging platform.

### 2. Description of the Related Art

In recent years, with rapid development of electronic technology and multimedia information, electronic products such as smart phones, tablet computers, and notebook computers are designed toward light, short, and powerful functions to have features of smaller size, lighter weight, and easy carry, and software and hardware of the electronic products are also continuously innovated, so that the electronic products can be used more flexibly and have improved practical effects, and become indispensable devices widely applied in people's work and life entertainment.

However, as the processing speed of the electronic product is improved, the mobile electronic device such as smart phone, tablet computer or notebook computer consumes more power. As a result, when a user operates a mobile electronic product while walking, the battery power of the mobile electronic device is quickly exhausted, and the user needs to find a power socket nearby to charge the battery of the mobile electronic device.

In teaching environment (for example, schools), in order to meet the requirement in digital teaching, teachers and students use mobile electronic devices, such as tablets or notebooks, to replace traditional books for knowledge transfer, so how to conveniently charge the mobile electronics becomes extremely important. Generally, a charging device, such as a charging cabinet or a charging car, can provide a plurality of AC sockets or DC charging sockets, such as USB sockets, disposed thereon to charge the plurality of mobile electronic devices through necessary chargers and charging lines. For example, there is an advance charging socket adopting a USB TYPE C interface and having a connector with an elliptical insertion hole, so that the mobile electronic device equipped with the above-mentioned connector can be charged without distinction between the front and back sides of the connector, thereby providing excellent convenience in charging operation. Furthermore, the USB TYPE C interface has a maximum output voltage of 20 volts (V), a maximum output current of 5 amps (A), and an output power higher than a traditional USB TYPE A interface. The size of the USB TYPE C interface can be smaller than that of the traditional USB TYPE A interface. The USB TYPE C interface can be mounted on a notebook computer to replace the traditional DC Jack, and have a size smaller than the traditional DC charging connector, and also be more practical than the traditional DC charging connector. Because of the above advantages, the charging transmission interface of the mobile electronic device has gradually been changed to the USB TYPE C interface.

The USB TYPE C interface has many advantages, but the tongue structure of the USB TYPE C connector is relatively light and fragile, so when the male plug connected to the power supply wire is frequently plugged and unplugged with the connector in the mobile electronic device, the power supply wire or the mobile electronic device connector is possibly damaged and cannot perform the charging function. Therefore, how to design a device for charging without plugging and unplugging with the connector, is a key issue in the industry.

### SUMMARY OF THE INVENTION

In order to solve the conventional problems, the inventors develop a quick positioning-charging device according to collected data, multiple tests and modifications, and years of experience in the industry.

An objective of the present invention is to provide a quick positioning-charging device. In the quick positioning-charging device, a charging platform includes a plurality of power-terminal connectors which each comprises a plurality of probe terminals, an insulating body and a female socket. The female socket is electrically connected to a power terminal. The quick positioning-charging device includes a plurality of accommodation frames assembled on the charging platform, and each accommodation frame includes an accommodation space configured to accommodate a mobile electronic device. A male plug on a side of an isolating member of a charging-terminal connector can be plugged with a charging hole of the mobile electronic device to form electrical connection. The charging-terminal connector comprises a plurality of contact points configured to elastically abut with the plurality of probe terminals of the power-terminal connector for forming electrical connection. The electrical connection structure of the mobile electronic device elastically abutted with the power-terminal connector of the charging platform can prevent the male plug connected to the power supply cable of the charging device from being frequently plugged and pulled with the connector of the mobile electronic device, thereby solving the conventional problem of the connector of the power supply cable or mobile electronic device being possibly damaged by the frequent plug-pull operations. As a result, the charging device of the present invention has advantages of quick positioning and convenient use.

Another objective of the present invention is that the accommodation frame can comprise a first partition plate and a second partition plate, the second partition plate has a plurality of side hooks disposed at a bottom thereof and configured to buckle a plurality of buckle grooves which correspond in position thereto and are formed on a bottom plate of the first partition plate, and the first partition plate has at least one locking plate disposed on a side thereof and having a locking hole, and a fastener can be inserted into the locking hole and fixed in a side wall of the charging platform. The bottom plate of the first partition plate includes a plurality of bottom hooks disposed on a bottom thereof and configured to buckle into a plurality of buckle holes which correspond in position thereto and are formed on a base plate of the charging platform, so as to fix the accommodation frame with the charging platform and form the accommodation space between the first partition plate and the second partition plate.

Another objective of the present invention is that the first partition plate and the second partition plate have two guiding grooves formed on opposite two inner sides, respectively, and a position-limiting block has sliding tracks formed on two opposite sides thereof and slid along and positioned in the two guiding grooves, and when a mobile electronic device with a smaller size is placed into the accommodation space, the position-limiting block can abut against and position the mobile electronic device in a vertical direction, so as to prevent the mobile electronic device from shaking and sliding.

### BRIEF DESCRIPTION OF THE DRAWINGS

The structure, operating principle and effects of the present invention will be described in detail by way of various embodiments which are illustrated in the accompanying drawings.

FIG. 1 is a perspective structural diagram of a quick positioning-charging device of the present invention.

FIG. 2 is an another perspective structural diagram of a quick positioning-charging device of the present invention.

FIG. 3 is a perspective exploded structural diagram of an accommodation frame of the present invention.

FIG. 4 is another perspective exploded structural diagram of an accommodation frame of the present invention.

FIG. 5 is another perspective exploded structural diagram of an accommodation frame of the present invention.

FIG. 6 is a side cross-sectional diagram of an embodiment of a quick positioning-charging device of the present invention.

FIG. 7 is a schematic view of a power-terminal connector and a charging-terminal connector mounted with a charging platform and a mobile electronic device, respectively, according to the present invention.

FIG. 8 is a schematic view of a power-terminal connector elastically abutted with a charging-terminal connector, according to the present invention.

### DETAILED DESCRIPTION OF THE PREFERRED EMBODIMENTS

The following embodiments of the present invention are herein described in detail with reference to the accompanying drawings. These drawings show specific examples of the embodiments of the present invention. These embodiments are provided so that this disclosure will be thorough and complete, and will fully convey the scope of the invention to those skilled in the art. It is to be acknowledged that these embodiments are exemplary implementations and are not to be construed as limiting the scope of the present invention in any way. Further modifications to the disclosed embodiments, as well as other embodiments, are also included within the scope of the appended claims. These embodiments are provided so that this disclosure is thorough and complete, and fully conveys the inventive concept to those skilled in the art. Regarding the drawings, the relative proportions and ratios of elements in the drawings may be exaggerated or diminished in size for the sake of clarity and convenience. Such arbitrary proportions are only illustrative and not limiting in any way. The same reference numbers are used in the drawings and description to refer to the same or like parts.

It is to be acknowledged that, although the terms ‘first’, ‘second’, ‘third’, and so on, may be used herein to describe various elements, these elements should not be limited by these terms. These terms are used only for the purpose of distinguishing one component from another component. Thus, a first element discussed herein could be termed a second element without altering the description of the present disclosure. As used herein, the term “or” includes any and all combinations of one or more of the associated listed items.

It will be acknowledged that when an element or layer is referred to as being “on,” “connected to” or “coupled to” another element or layer, it can be directly on, connected or coupled to the other element or layer, or intervening elements or layers may be present. In contrast, when an element is referred to as being “directly on,” “directly connected to” or “directly coupled to” another element or layer, there are no intervening elements or layers present.

In addition, unless explicitly described to the contrary, the word “comprise” and variations such as “comprises” or “comprising”, will be acknowledged to imply the inclusion of stated elements but not the exclusion of any other elements.

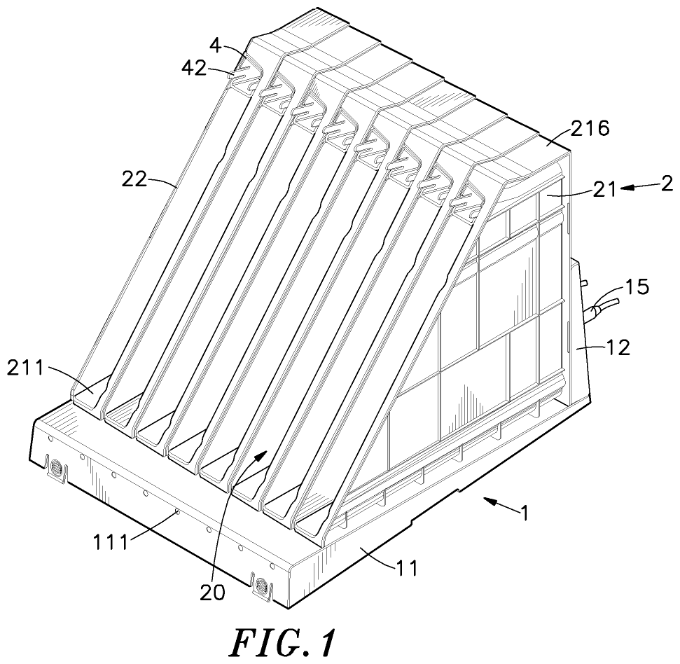

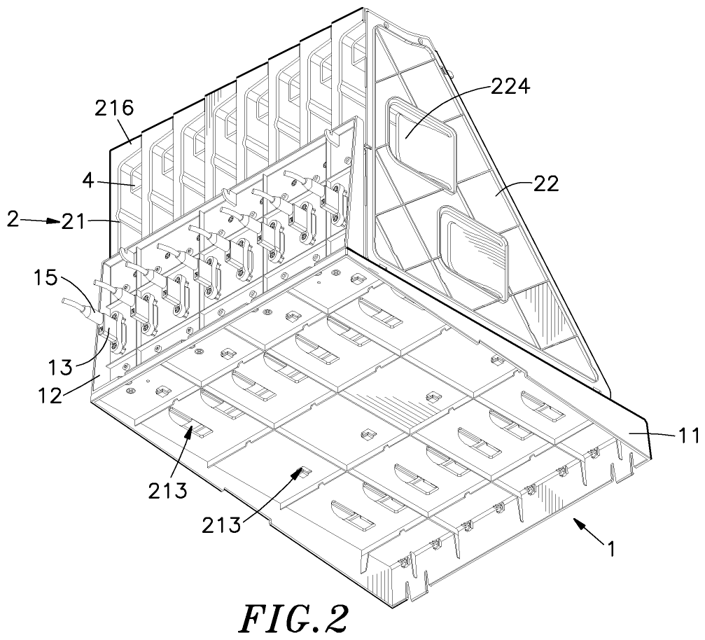

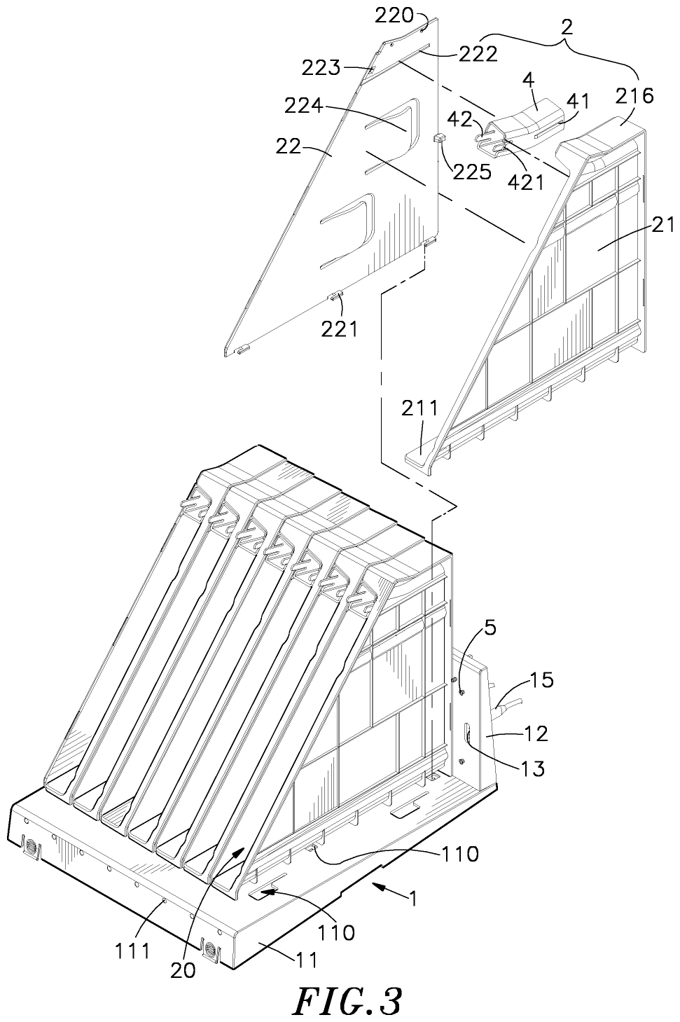

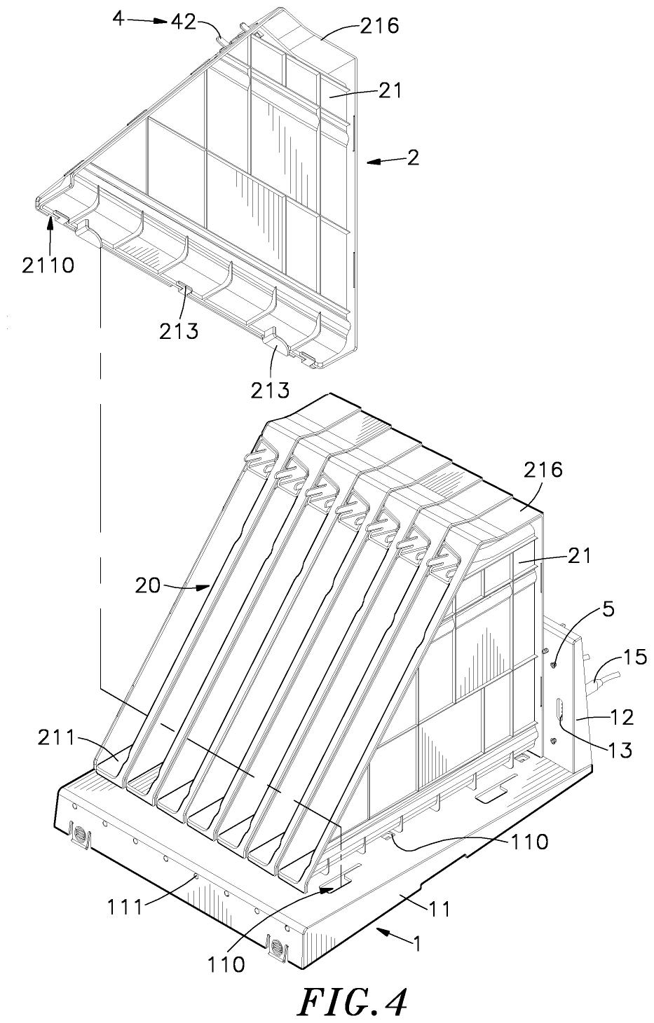

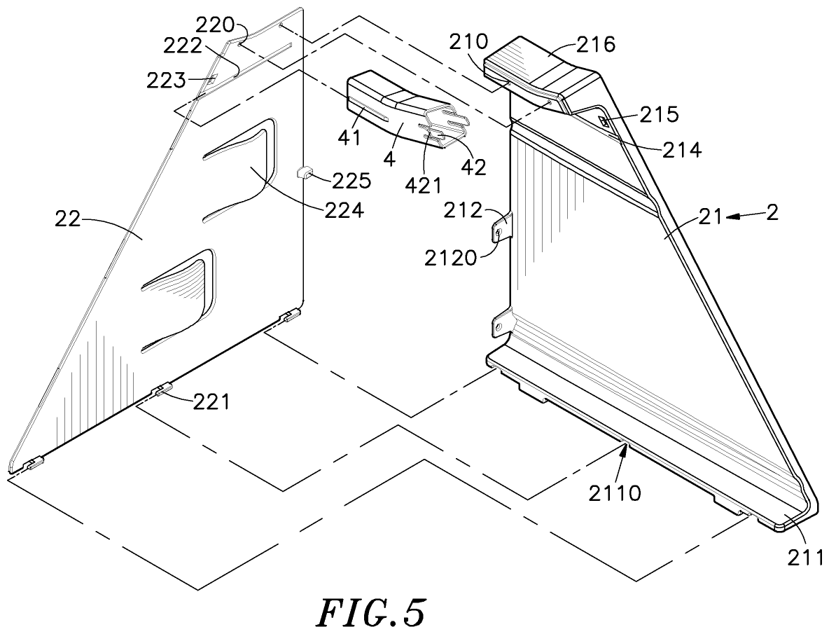

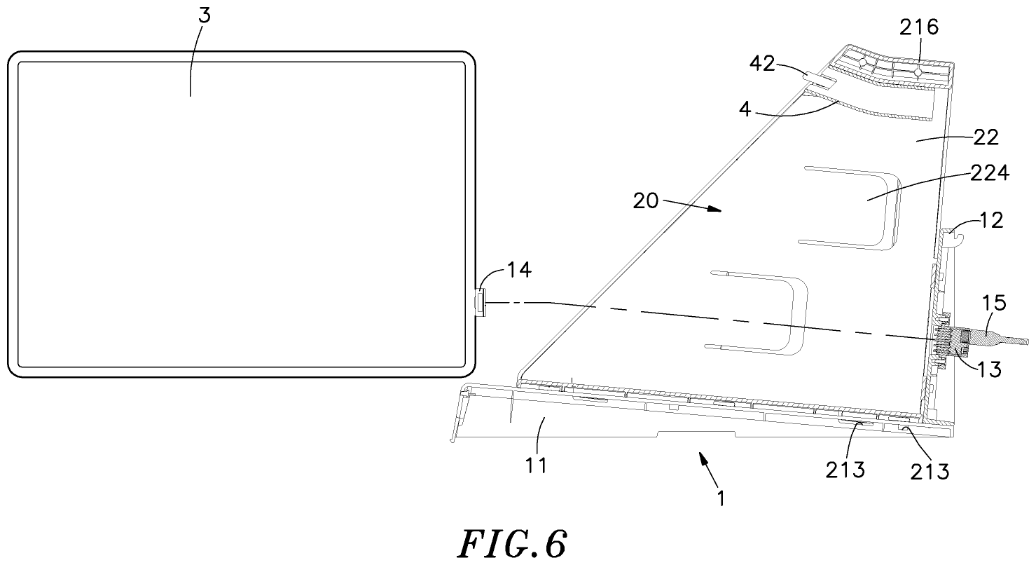

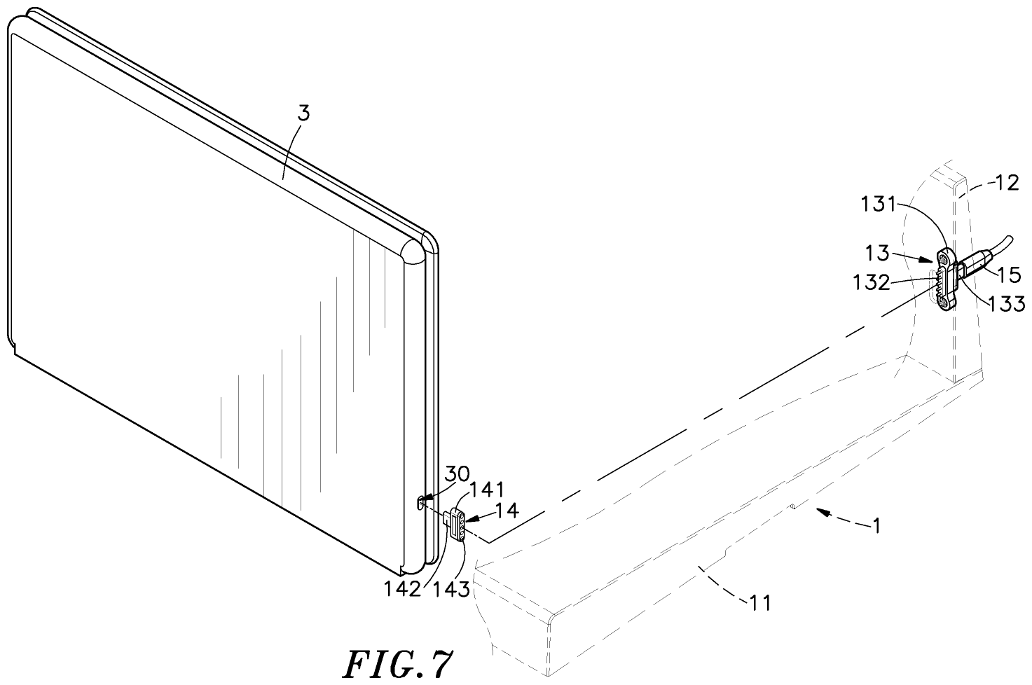

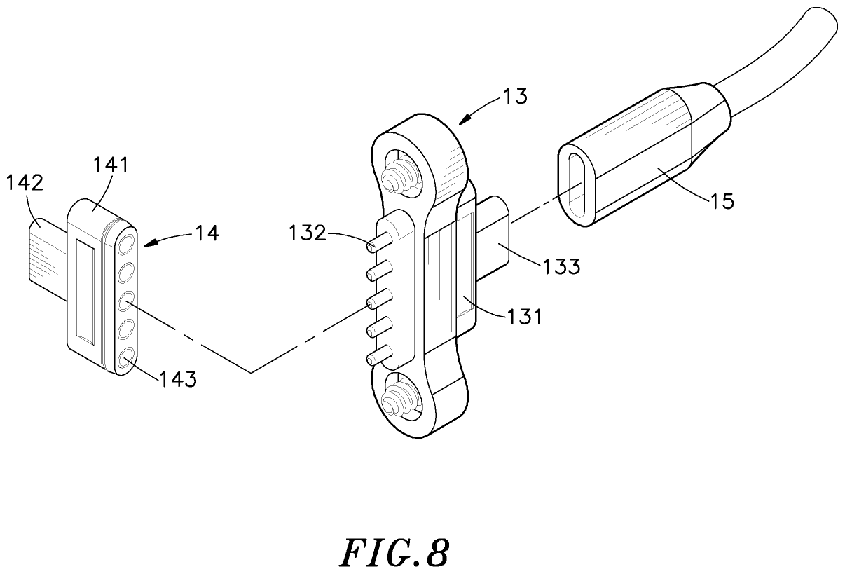

Please refer to FIGS. 1 to 8, which are perspective structural diagrams of a quick positioning-charging device of the present invention, perspective exploded structural diagrams of an accommodation frame, a side cross-sectional diagram of an embodiment of a quick positioning-charging device, a schematic view of a power-terminal connector and a charging-terminal connector mounted with the charging platform and the mobile electronic device respectively, and a schematic view of a power-terminal connector elastically abutted with a charging-terminal connector, according to the present invention. As shown in FIGS. 1 to 8, a quick positioning-charging device of the present invention mainly includes a charging platform 1, an accommodation frame 2, a mobile electronic device 3, a position-limiting block 4 and a fastener 5. The connection relationships of these structures are described in following paragraphs.

The charging platform 1 is formed by a base plate 11 disposed laterally and a side wall 12 disposed vertically, and the base plate 11 has an inclined angle which is inclined downwardly from an entrance of the charging platform to the side wall 12. In an embodiment, the inclined angle can be in a range of 5 degrees to 15 degrees. The inclined angle of the base plate 11 is beneficial for sliding smoothness of the mobile electronic device 3. The charging platform 1 comprises a plurality of power-terminal connectors 13 disposed thereon, and each power-terminal connector 13 comprises a plurality of probe terminals 132, an insulating body 131 and a female socket 133. The plurality of probe terminals 132 are elastically stretchable in the insulating body 131. The female socket 133 are electrically connected to a charging plug 15 of a power terminal.

The charging platform 1 can comprise a plurality of indicator lights 111 disposed on the base plate 11 thereof In an embodiment, the indicator lights can include light-emitting diodes. The indicator light 111 can be used to display whether the mobile electronic device 3 is electrically connected to the power-terminal connector 13 of the charging platform 1. Those skilled in the art can also replace light-emitting diodes with a LCD screen having a backlight module, to perform the same function; this equivalent alteration or modification is covered by the claim scope of the present invention.

The plurality of accommodation frames 2 are assembled on the charging platform 1, and each accommodation frame 2 comprises an accommodation space 20 configured to accommodate the mobile electronic device 3. In an embodiment, the mobile electronic device 3 can be a notebook computer or a tablet computer. A male plug 142 on a side of an isolating member 141 of a charging-terminal connector 14 can be plugged with a charging hole 30 of the mobile electronic device 3 to form electrical connection. The charging-terminal connector 14 can comprise a plurality of contact points 143 configured to elastically abut with the plurality of probe terminals 132 of the power-terminal connector 13 for forming electrical connection. In an embodiment, the female socket 133 of the power-terminal connector 13 and the male plug 142 of the charging-terminal connector 14 can be formed by USB TYPE C interface connectors.

The accommodation frame 2 can comprise a first partition plate 21 and a second partition plate 22. The second partition plate 22 has a plurality of side hooks 221 disposed at a bottom thereof and configured to buckle a plurality of buckle grooves 2110 which correspond in position thereto and are formed on a bottom plate 211 of the first partition plate 21. The first partition plate 21 has at least one locking plate 212 disposed on a side thereof and having a locking hole 2120. The fastener 5, such as a screw or rivet, can be inserted into the locking hole 2120 and fixed in the side wall 12 of the charging platform 1. The bottom plate 211 of the first partition plate 21 can have a plurality of bottom hooks 213 disposed on a bottom thereof and configured to buckle into a plurality of buckle holes 110 which correspond in position thereto and are formed on the base plate 11 of the charging platform 1, so as to fix the accommodation frame 2 with the charging platform 1 and form the accommodation space 20 between the first partition plate 21 and the second partition plate 22. The first partition plate 21 has a cover plate 216 laterally extended from and disposed on an upper part thereof.

The first partition plate 21 and the second partition plate 22 have two guiding grooves formed on opposite two inner sides thereof, respectively. The two guiding grooves have a first guiding groove 214 formed on the first partition plate 21 and a second guiding groove 222 formed on the second partition plate 22. The position-limiting block 4 has sliding tracks 41 disposed two opposite sides thereof and slid along and positioned in the two guiding grooves 214 and 222. When the mobile electronic device 3 with a smaller size is placed in the accommodation space 20, the position-limiting block 4 can abut against and position the mobile electronic device 3 in a vertical direction, so as to prevent the mobile electronic device 3 from shaking and sliding. Furthermore, the position-limiting block 4 can be removed from the accommodation space 20 to form a larger space to accommodate the mobile electronic device 3 with a larger size. When the mobile electronic device 3 with a larger size is placed in the accommodation space 20, the mobile electronic device 3 is directly abutted with and positioned by the bottom of the first partition plate 21 in a vertical direction. In an embodiment, the thickness of the position-limiting block 4 can be varied to enable the accommodation frame 2 to accommodate the mobile electronic device 3 of different size, so that usage of the position-limiting block 4 can make the accommodation frame 2 have greater flexibility in accommodating the mobile electronic device 3 of different size.

The position-limiting block 4 has two holding parts 42 disposed on a side thereof, and the two holding parts 42 have two positioning blocks 421 disposed on opposite two outer sides thereof, respectively, and configured to engage with positioning holes formed on the opposite two inner sides of the first partition plate 21 and the second partition plate 22, so as to fix the position-limiting block 4 in the accommodation frame 2. The positioning holes includes a first positioning hole 215 formed on the first partition plate 21 and a second positioning hole 223 formed on the second partition plate 22.

The second partition plate 22 has a plurality of through holes 220 formed on an upper part thereof, and a plurality of fasteners (not shown in figures) can be inserted into the through holes 220 and locked with a plurality of locking grooves 210 which correspond in position thereto and are formed on the cover plate 216 of the first partition plate 21, so as to fix the first partition plate 21 with the second partition plate 22.

At least one spring clip 224 and at least one stop block 225 can be disposed between the first partition plate 21 and the second partition plate 22. The at least one spring clip 224 and the at least one stop block 225 are abutted with an outer shell of the mobile electronic device 3, such as notebook computer or tablet computer, in a lateral direction, so as to prevent the mobile electronic device 3 from shaking and sliding.

In an embodiment, a plurality of quick positioning-charging devices of the present invention can be applied and mounted in a charging cabinet or a charging car. The difference between the charging cabinet and the charging car in that the charging cabinet is a fixed charging device and the charging car is a mobile charging device. The charging cabinet or the charging car can include a plurality of charging platforms 1 disposed therein, and each charging platform 1 has a plurality of accommodation frames 2 which each has an accommodation space 20 for a mobile electronic device 3 to be placed. The mobile electronic device 3 can be a notebook computer or a tablet computer. A charging-terminal connector 14 can be plugged with the charging hole 30 of the mobile electronic device 3. The charging platform 1 comprises a plurality of power-terminal connectors 13 disposed thereon, and the plurality of probe terminals 132 of each power-terminal connector 13 are elastically stretchable in an insulating body 131, and a female socket 133 of the power-terminal connector 13 can be electrically connected to a charging plug 15. When the mobile electronic device 3 is placed in the accommodation frame 2, the charging platform 1 having the inclined angle can improve the sliding smoothness of the mobile electronic device 3 and the electrical connection reliability between the mobile electronic device 3 and the power-terminal connector 13. The charging-terminal connector 14 comprises the plurality of contact points 143 configured to elastically abut with the plurality of probe terminals 132 of the power-terminal connector 13 to form electrical connection. Light signals of a plurality of the indicator lights 111 on a base plate 11 of the charging platform 1 can be changed to show whether the mobile electronic device 3 is electrically connected to the power-terminal connector 13 of the charging platform 1 correctly. For example, the change in the light signals can be a change from red light to green light, or no light to green light. The electrical connection structure of the mobile electronic device 3 elastically abutted with the power-terminal connector 13 of the charging platform 1 can prevent the male plug, connected to the power supply cable of the conventional charging device, from being frequently plugged and pulled with the connector of the mobile electronic device, so as to further protect the connector of the power supply cable or mobile electronic device from being damaged by the frequent plug-pull operations.

As shown in FIGS. 1 to 8, it can be understood that the present invention provides a quick positioning-charging device, including the charging platform which includes the plurality of power-terminal connectors. Each power-terminal connector comprises the plurality of probe terminals, the insulating body and the female socket. The female socket is electrically connected to the power terminal. The quick positioning-charging device includes the plurality of accommodation frames assembled on the charging platform, and each accommodation frame comprises the accommodation space configured to accommodate a mobile electronic device. The male plug on a side of the isolating member of the charging-terminal connector can be plugged with the charging hole of the mobile electronic device, to form electrical connection. The charging-terminal connector comprises the plurality of contact points configured to elastically abut with the plurality of probe terminals of the power-terminal connector, respectively, so as to form electrical connection. The charging device of the present invention has the advantages of quick positioning and convenience in use, and can be applied to the charging cabinet or the charging car and have great commercial market opportunities.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A quick positioning-charging device, comprising:
a charging platform comprising a plurality of power-terminal connectors disposed thereon, each of the plurality of power-terminal connectors comprising a plurality of probe terminals, an insulating body and a female socket, wherein the plurality of probe terminals are elastically stretchable in the insulating body, and the female socket is electrically connected to a charging plug of a power terminal; and
a plurality of accommodation frames assembled on the charging platform, wherein each of the plurality of accommodation frames comprises an accommodation space configured to accommodate a mobile electronic device, the mobile electronic device comprises a charging hole configured for insertion of a male plug on a side of an isolating member of a charging-terminal connector to form electrical connection, the charging-terminal connector comprises a plurality of contact points configured to elastically abut with the plurality of probe terminals of the power-terminal connector to form electrical connection, and the female socket of the power-terminal connector and the male plug of the charging-terminal connector are formed by USB TYPE C interface connectors.

2. The quick positioning-charging device according to claim 1, wherein each of plurality of the accommodation frames comprises a first partition plate and a second partition plate, the second partition plate has a plurality of side hooks disposed at a bottom thereof and configured to buckle a plurality of buckle grooves which correspond in position thereto and are formed on a bottom plate of the first partition plate, and the first partition plate has at least one locking plate disposed on a side thereof and having a locking hole configured for insertion of a fastener, and the fastener is fixed in a side wall of the charging platform, and the bottom plate of the first partition plate has a plurality of bottom hooks disposed on a bottom thereof and configured to buckle into a plurality of buckle holes which correspond in position thereto and are formed on a base plate of the charging platform, so as to fix the accommodation frame and the charging platform, wherein the accommodation space is formed between the first partition plate and the second partition plate.

3. The quick positioning-charging device according to claim 2, wherein the first partition plate and the second partition plate have two guiding grooves formed on opposite two inner sides thereof, respectively, and the quick positioning-charging device comprises a position-limiting block which has sliding tracks formed on two opposite sides thereof and slid along and positioned in the two guiding grooves, and when a mobile electronic device with a smaller size is placed into the accommodation space, the position-limiting block abuts against and positions the mobile electronic device in a vertical direction, so as to prevent the mobile electronic device from shaking and sliding.

4. The quick positioning-charging device according to claim 3, wherein the position-limiting block has two holding parts disposed on a side thereof, and the two holding parts have two positioning blocks disposed on opposite two outer sides thereof, respectively, and configured to engage with positioning holes formed on the opposite two inner sides of the first partition plate and the second partition plate, so as to fix the position-limiting block in an accommodation frame.

5. The quick positioning-charging device according to claim 2, wherein the second partition plate has a plurality of through holes formed on an upper part thereof, and the plurality of fasteners are inserted into the plurality of through holes and locked with a plurality of locking grooves which correspond in position thereto and are formed on a cover plate above the first partition plate, so as to fix the first partition plate with the second partition plate.

6. The quick positioning-charging device according to claim 2, further comprising at least one spring clip and at least one stop block disposed between the first partition plate and the second partition plate, wherein the at least one spring clip and the at least one stop block are abutted with an outer shell of a mobile electronic device in a lateral direction, to prevent the mobile electronic device from shaking and sliding.

7. The quick positioning-charging device according to claim 2, wherein the charging platform is formed by the base plate disposed laterally and a side wall disposed vertically, the base plate has an inclined angle which is inclined downwardly from an entrance of the charging platform to the side wall, and the inclined angle of the base plate is beneficial for sliding smoothness of a mobile electronic device.

8. The quick positioning-charging device according to claim 7, wherein the inclined angle of the base plate is in a range of 5 degrees to 15 degrees.

9. The quick positioning-charging device according to claim 1, wherein a base plate of the charging platform comprises a plurality of indicator lights configured to display whether the mobile electronic device is electrically connected to the power-terminal connector of the charging platform.

10. The quick positioning-charging device according to claim 1, wherein the mobile electronic device is a notebook computer or a tablet computer.
